(19) United States
(12) Patent Application Publication
(10) Pub. No.: US 2011/0108425 A1
(43) Pub. Date: May 12, 2011

(54) METHOD FOR PRODUCING KARAT GOLD JEWELRY ITEMS AND A JEWELRY ITEM MADE IN ACCORDANCE THEREWITH

(76) Inventors: Dov YELIN, Ramat-Hasharon (IL); Gad Iram, Kefar-Shemaryahoo (IL)

(21) Appl. No.: 12/617,091

(22) Filed: Nov. 12, 2009

(51) Int. Cl. B32B 15/04; C25D 5/34; C25D 3/00

(52) U.S. Cl. 205/50; 205/205; 205/183

(57) ABSTRACT

The present invention relates to the manufacture of karat gold jewelry items. The invention provides a method for manufacturing karat gold jewelry comprising producing a non metallic material form corresponding to the shape and size of the desired jewelry item, the form being molded in a metal die. Treating the surface of the non metallic material form to make the surface electrically conductive and receptive to an electroplating process; and adding a layer of karat gold not less than 15 micron thickness to the treated form by means of an electroplating process to produce a jewelry item.

### BACKGROUND AND FIELD OF THE INVENTION

The present invention relates to the manufacture of karat gold jewelry items.

Karat gold jewelry items may be manufactured by various procedures. Items may be made of solid karat gold, or may have gold plating on a metallic core, may have a karat gold shell and a hollow interior. Presently the price of pure gold is around $1000 per ounce, which provides an incentive for manufacturers to devise new ways for producing quality jewelry while using less of this precious metal. Solid karat gold jewelry items such as wedding rings will continue to be available, although the market for luxury goods of this type is forecast to decline.

The following review of US Patents provides a fair assessment of the current state of the art.

U.S. Pat. No. 4,403,014 discloses a method for depositing a hard coating of a karat gold compound on a substrate for coating jewelry in a high-purity argon atmosphere. During plating an alloying substance such as nitride, carbide, boride or tantalum is added to the gold to provide a strong shell which can be plated by an outer layer of pure karat gold. The process operates in the vapor phase and so requires high operating temperatures.

A similar method for electroforming a karat gold jewelry article is disclosed in U.S. Pat. No. 5,393,405, the main difference relative to the previous patent being operation in the liquid phase which can be effected at a moderate temperature.

U.S. Pat. Nos. 6,092,358 and 6,381,942 disclose a process for manufacturing a jewelry wire having a silver core and a thin external coating of karat gold, typically 0.001 inch thick. A karat gold sheet strip is drawn into an open channel containing a solid silver core. The channel member is closed about the solid core to produce a solid tubular wire used to produce jewelry wire items.

It can thus be surmised that there is required a process using karat gold which can produce a jewelry article having the strength needed to remain mechanically stable in normal day-to-day use, while costing much less than would a solid karat gold article.

Contrary to the known golden jewelry according to the invention the jewelry obtained is 15-100 micron, so the only metal in the item is karat gold.

### OBJECTS OF THE INVENTION

It is therefore one of the objects of the present invention to obviate at least some of the disadvantages of prior art jewelry production methods and to provide a jewelry item low in cost and a method to produce same.

A further object of the present invention may be to provide a low-cost yet reliable method of attaching clasping components to the article being produced.

### SUMMARY OF THE INVENTION

The present invention may achieve at least some of the above objects by providing a method for manufacturing karat gold jewelry comprising the steps of: (a) producing a non metallic material form corresponding to the shape and size of the desired jewelry item, said form being molded in a metal die; (b) treating the surface of said non metallic material form to make said surface electrically conductive and receptive to an electroplating process; and (c) adding a layer of karat gold (14, 18) not less than 15 micron thickness to said treated form by means of an electroplating process to produce a jewelry item.

### BRIEF DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized, in which:

FIG. 1 is a block diagram representing a process according to an embodiment of the present invention;

FIG. 2 is a perspective view of a clasp component which is assembled to a jewelry earring during molding of the mandrel according to an embodiment of the present invention;

FIG. 3 is a perspective sectioned view of the earring looking in the direction of the arrow A;

FIG. 4 is a view of a perspective view of the finished earring; and

FIG. 5 is an enlarged sectional view of the earring similar to that seen at the bottom of FIG. 3.

### DETAILED DESCRIPTION OF EMBODIMENTS OF THE INVENTION

According to an embodiment of the invention, there is provided a method for manufacturing karat gold jewelry comprising the steps of: (a) producing a non metallic material form corresponding to the shape and size of the desired jewelry item, said form being molded in a metal die; (b) treating the surface of said non metallic material form to make said surface electrically conductive and receptive to an electroplating process; and (c) adding a layer of karat gold (14, 18) not less than 15 micron thickness to said treated form by means of an electroplating process to produce a jewelry item.

In some embodiments of the invention, the metal die may be arranged for injection molding.

In a further embodiment of the invention, clasp components may be inserted into the metal die before starting the molding process, said clasp components becoming firmly anchored to and projecting from said non metallic material form produced during the molding process.

In an embodiment of the invention, the thickness of said added karat gold layer may be selected in a range of 15-100 micron.

In an embodiment of the invention, the surface treatment may be a chemical treatment.

In yet another embodiment of the invention, there is provided a jewelry item made according to the following method: (a) producing a non metallic material form corresponding to the shape and size of the desired jewelry item, said form being molded in a metal die; (b) treating the surface of said non metallic material form to make said surface electrically conductive and receptive to an electroplating process; and (c) adding a layer of karat gold not less than 15 micron thickness to said treated form by means of an electroplating process to produce said jewelry item.

In an embodiment of the invention, there is provided a jewelry item made according to the method described above, wherein clasp components are inserted into said metal die before starting the molding process, said clasp components becoming firmly anchored to and projecting from said non metallic material form produced during the molding process.

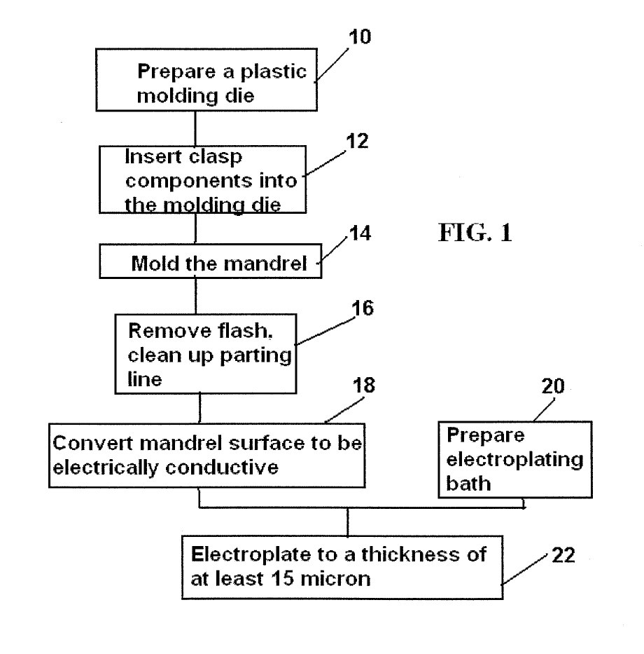

There is seen in FIG. 1 a representation of the method for manufacturing karat gold jewelry comprising the below-described steps.

The step marked 10 refers to the preparation of a die for non metallic material molding. Preferably the die is arranged for injection molding. The die will be provided with multiple cavities if large scale production of the jewelry article is anticipated.

Each main die cavity is provided with sub-cavities which hold and position clasp components, typically made of solid karat gold, which have been prepared separately. Insertion of these components is represented by box 12. These components, which are needed for example for an caning or a brooch, will become firmly attached to the body of the mandrel which is to be produced by the die. The non metallic material mandrel becomes an integral part of the jewelry item to be manufactured.

The next step is the production of the non metallic mandrel corresponding to the shape and size of the desired jewelry item. The mandrel form is molded, box 14, in a metal die by standard and well known molding methods. The preferred polymers are ABS or other material which are available in plating grades. These materials have a long history of successful use in plating applications. Many other plastics can be used, if there is an operational reason to do so.

As a result of the molding process the clasp components are firmly anchored to and project from the plastic form produced in the die.

As the karat gold article will have the same shape as the mandrel form, box 16 represents the removal of any imperfection in the molded mandrel. Usually all that needs doing is smoothing the molded form around the die parting line, and removing any flash therefrom if necessary.

Box 18 represents treating the surface of the non metallic material form to make the surface electrically conductive and receptive to an electroplating process. This can be achieved by the sub-steps of sensitization, nucleation, post-nucleation and rinsing. These processes are partly chemical in effect, and are described in detail in standard textbooks and will not be discussed further here.

Karat gold plating is carried out in a cyanide bath, the source of the karat gold being Au(CN)₂+ Cu and Ag salts.

Referring now to the preparation of the electroplating bath, box 20, Potassium gold cyanide is preferable to the equivalent sodium salt. Its slightly higher cost is easily recouped because it provides the ion Au(CN)₂₋ which results in a more stable complex. For best results the plating solution is filtered through activated carbon before adding the gold salt and the other salts to the bath. Good results can be achieved using acid, neutral or alkaline baths, and each manufacturer will choose the type of bath with which he is familiar and which is suitable for the equipment he has installed. For the purest karat gold deposits the acid bath is preferred. However the alkaline solutions offer the advantage of preventing any possible release to the atmosphere of hydrocyanic acid.

Box 22 represents the electroplating process. Depending on the bath selected, current density can be anywhere between 10-200 Amperes per square meter. A minimum of 15 micron karat gold is deposited, and depending on commercial considerations regarding the end product, plating can be continued to produce a 100 micron thick skin.

The karat gold layer obtained is commercially alloyed gold such as 14 or 18 karat.

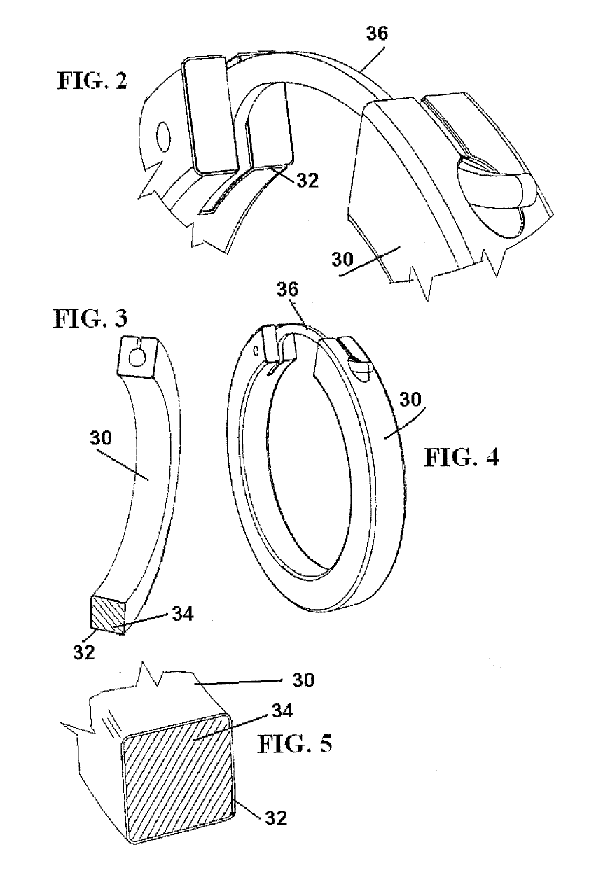

Referring now to FIGS. 2, 3, 4 and 5 there is seen a karat gold jewelry ring 30 which could be used as a bracelet, an earring, a finger ring or the like. The karat gold skin 32 of the article is well supported by the non metallic material mandrel 34 which remains in place. The clasp unit 36 was inserted into the molding die (not shown) before entry therein of the melted non metallic material.

The karat gold skin 32 of the ring 30 adheres to the core non metallic material formed mandrel 34 which provides adequate support to the skin 32.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

We claim:

1. A method for manufacturing karat gold jewelry comprising:
(a) producing a non metallic material form corresponding to the shape and size of the desired jewelry item, said form being molded in a metal die;
(b) treating the surface of said non metallic material form to make said surface electrically conductive and receptive to an electroplating process; and
(c) adding a layer of karat gold (14, 18) not less than 15 micron thickness to said treated form by means of an electroplating process to produce a jewelry item.

2. The method as claimed in claim 1, wherein said metal die is arranged for injection molding.

3. The method as claimed in claim 1, wherein clasp components are inserted into said metal die before starting the molding process, said clasp components becoming firmly anchored to and projecting from said non metallic material form produced during the molding process.

4. The method as claimed in claim 1, wherein the thickness of said added karat gold layer may be selected in a range of 15-100 micron.

5. The method as claimed in claim 1, wherein said karat gold layer is commercially alloyed karat gold.

6. The method as claimed in claim 1, wherein said surface treatment is a chemical treatment.

7. The method as claimed in claim 1, wherein said surface treatment comprises applying a thin even coating of an electrically conductive lacquer to said plastic form.

8. A jewelry item made according to the method as claimed in claim 1.

9. A jewelry item made according to the method as claimed in claim 3.
